(19) United States
(12) Patent Application Publication
(10) Pub. No.: US 2008/0211852 A1
(43) Pub. Date: Sep. 4, 2008

(54) Recording medium, print control device, printing system, and computer readable medium

(75) Inventor: Masatoshi Araki, Kanagawa (JP)

Correspondence Address: FILDES & OUTLAND, P.C., 20916 MACK AVENUE, SUITE 2, GROSSE POINTE WOODS, MI, 48236, US

(73) Assignee: Fuji Xerox Co., Ltd.

(21) Appl. No.: 11/893,315

(22) Filed: Aug. 14, 2007

(30) Foreign Application Priority Data
Mar. 2, 2007 (JP) P2007-052611

(51) Int. Cl. B41J 29/393

(52) U.S. Cl. 347/19

(57) ABSTRACT

A recording medium on which a test image testing an operation to a plurality of liquid droplet ejecting elements arrayed in a liquid droplet ejecting head is drawn, the test image comprising a straight line set having a predetermined number of straight lines which are evenly spaced from each other, and being drawn parallel to each other in a predetermined direction, each of the straight lines having start points and end points which are disposed thereon, and the test image having ratio of width of each of the straight lines to interval between the straight lines adjacent to each other, the ratio satisfying the following formula (1):

0.15<the width of each of the straight lines/the interval between the straight lines<0.90 . (1)

### CROSS-REFERENCE TO RELATED APPLICATIONS

This application is based on and claims priority under 35 U.S.C. 119 from Japanese Patent Application No. 2007-052611 filed Mar. 2, 2007.

### BACKGROUND

1. Technical Field

The present invention relates to a recording medium, a print control device, a printing system, and a computer readable medium.

2. Related Art

In recent years, increases in density and in the number of print elements of a print head have progressed with an increase in speed and an improvement in image quality of a printer. In particular, there has been proposed a plurality of printers including a print head having a print width equal to or larger than the width of a recording area, which can perform a printing operation on a part corresponding to a page width collectively. Among the printers, there are printers having the number of print elements such as liquid droplet ejecting elements as many as several thousands of print elements, which are mounted on the print head.

In the known printers, a plurality of methods for compensating a printing operation and minimizing deterioration of an image quality has been proposed by specifying a print element having an operation defect such as an ejection directional defect in which an ejection direction of ink is deviated from a normal direction or a non-ejection defect in which ejection of the ink is invalid. For this reason, it is very important to specify the print element having the operation defect.

### SUMMARY

According to an aspect of the present invention, a recording medium on which a test image testing an operation to a plurality of liquid droplet ejecting elements arrayed in a liquid droplet ejecting head is drawn, the test image comprising a straight line set having a predetermined number of straight lines which are evenly spaced from each other, and being drawn parallel to each other in a predetermined direction, each of the straight lines having start points and end points which are disposed thereon, and the test image having ratio of width of each of the straight lines to interval between the straight lines adjacent to each other, the ratio satisfying the following formula (1):

0.15<the width of each of the straight lines/the interval between the straight lines<0.90 (1).

### BRIEF DESCRIPTION OF THE DRAWINGS

Exemplary embodiment of the present invention will be described in detail based on the following figures, wherein:

FIG. 1 is a functional block diagram of a printing system according to an embodiment of the invention;

FIGS. 2A to 2C are explanatory diagrams of a test image;

FIG. 3 is an explanatory diagram of a method of drawing a test image;

FIGS. 4A and 4B are diagrams illustrating another example of a test image;

FIG. 5 is a diagram illustrating an array example of a liquid droplet ejecting element in a liquid droplet ejecting head;

FIGS. 6A and 6B are diagrams illustrating an example of a table used for specifying a liquid droplet ejecting element having an ejection directional defect;

FIG. 7 is a diagram illustrating another example of a test image;

FIG. 8 is a flowchart of an operation example of a print control device according to an embodiment of the invention;

FIG. 9 is a flowchart of another operation example of a print control device according to an embodiment of the invention;

FIG. 10 is a diagram illustrating another example of a test image;

FIG. 11 is a flowchart of another operation example of a print control device according to an embodiment of the invention; and

FIG. 12 is a diagram illustrating a test result of a discriminable range of an ejection directional defect.

### DETAILED DESCRIPTION

Hereinafter, a best mode for carrying out the invention (hereinafter, referred to as “embodiment”) will be described with reference to the accompanying drawings.

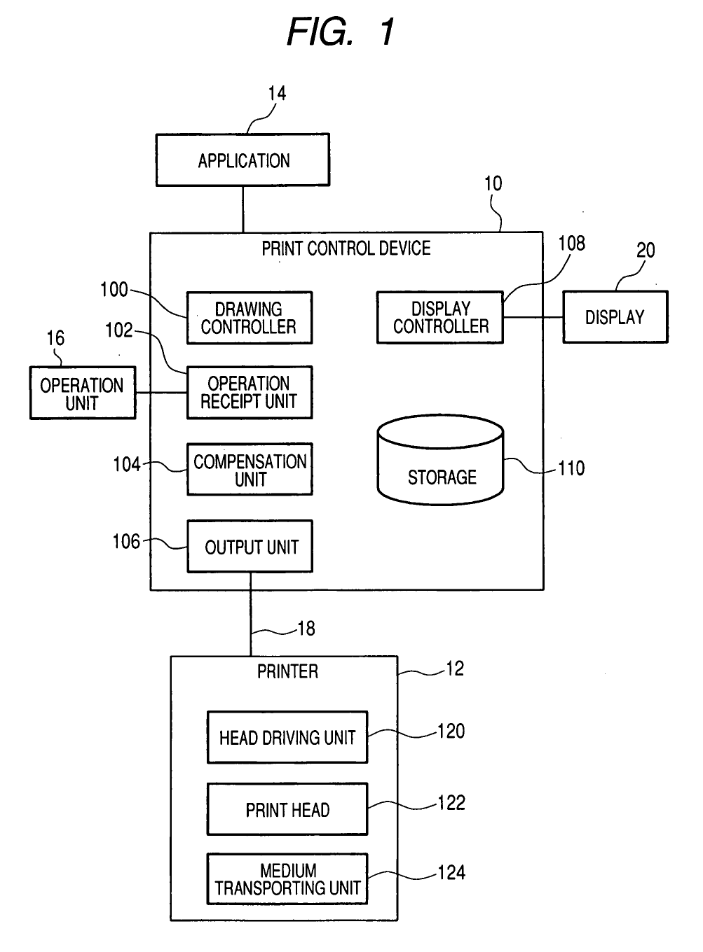

FIG. 1 is a functional block diagram of a printing system according to an embodiment of the invention. In FIG. 1, the printing system includes a print control device 10 and a printer 12. The print control device 10 converts image data as a printing target, which is acquired from an application 14, into data of a format which can be processed by the printer 12 and outputs the converted data to the printer 12. The printer 12 prints out the converted image data received from the print control device 10. The application 14 is general software having a function to output the image data as the printing target to the print control device 10 in accordance with a printing command.

The print control device 10 includes a drawing control unit 100, an operation receipt unit 102, a compensation unit 104, an output unit 106, a display control unit 108, and a storage unit 110.

The drawing control unit 100 is realized by a central processing unit (CPU) and a program for controlling a processing operation of the CPU. The drawing control unit 100 converts the image data acquired from the application 14 into print data which can be processed by the printer 12. The drawing control unit 100 generates test image data so as to draw the test image data for checking operation statuses of a plurality of liquid droplet ejecting elements arrayed in the liquid droplet ejecting head of the printer 12 to be described later to a recording medium. The test image data may be generated by means of data previously stored in the storage unit 110 and data acquired from the outside via proper communication interfaces such as a USB (Universal Serial Bus) port, a network port, and the like.

The operation receipt unit 102 is realized the CPU and the program for controlling the processing operation of the CPU. The operation receipt unit 102 receives an input from an operation unit 16. The input includes defect information on a liquid droplet ejecting element having an operation defect such as a non-ejection defect or an ejection directional defect among the plurality of liquid droplet ejecting elements arrayed in the liquid droplet ejecting head 122 disposed in the printer 12. The defect information includes the number of the liquid droplet ejecting element having the operation defect.

The compensation unit 104 is realized by the CPU and the program for controlling the processing operation of the CPU. The compensation unit 104 generates compensation information used for compensating the printing operation of the liquid droplet ejecting head 122 on the basis of the defect information. When the compensation information is generated, the compensation unit 104 also performs a process of specifying the liquid droplet ejecting element having the operation defect. Specifying the liquid droplet ejecting element having the operation defect will be described later.

The output unit 106 is realized by the CPU and the program for controlling the processing operation of the CPU. The output unit 106 outputs the print data and the test image data generated by the drawing control unit 100 to the printer 12 via a communication unit 18.

The display control unit 108 is realized by the CPU and the program for controlling the processing operation of the CPU. The display control unit 108 controls an operation of displaying an image for requesting input of the defect information of a user on a display unit 20.

The storage unit 110 is realized by a Random Access Memory (RAM) used as a working memory of the CPU, a magnetic storage device such as a hard disk device, and a computer-readable storage device. The storage unit 110 stores the program for controlling the processing operation of the CPU and the test image data.

The operation unit 16 is realized by data input devices such as a keyboard, a mouse, and a touch panel. The operation unit 16 allows the user to input the defect information on the liquid droplet ejecting element having the operation defect. The communication unit 18 is realized by the proper communication interfaces such as the USB (Universal Serial Bus) port, the network port, and the like. The communication unit 18 transmits and receives data between the output unit 106 and the printer 12. The display unit 20 is realized by a display device such as a liquid crystal display. The display unit 20 displays various images on the basis of the control performed by the display control unit 108.

The printer 12 includes a head driving unit 120, the liquid droplet ejecting head 122, and a medium transporting unit 124.

The head driving unit 120 controls an operation of the liquid droplet ejecting head 122 on the basis of the print data and the test image data received from the print control device 10.

The liquid droplet ejecting head 122 is constituted by the plurality of liquid droplet ejecting elements for ejecting ink droplets arrayed therein. The liquid droplet ejecting head 122 prints the image on the recording medium such as printing paper. The liquid droplet ejecting element is constituted by a capacitive load such as a piezoelectric element.

The medium transporting unit 124 transports a recording medium on which the image is printed by the liquid droplet ejecting head 122 in synchronization with a print timing of the liquid droplet ejecting head 122.

In the embodiment, the printer equipped with the liquid droplet ejecting head ejecting the ink droplets is exemplified, but is not limited to it. A color filter manufacturing device manufacturing a color filter by ejecting ink onto a film or a glass, a device forming a bump for mounting components by ejecting dissolved solder onto a substrate, a device forming a wiring pattern ejecting liquid metal, and various coating devices forming a film by ejecting the liquid droplets may be used as the printer equipped with the liquid droplet ejecting head.

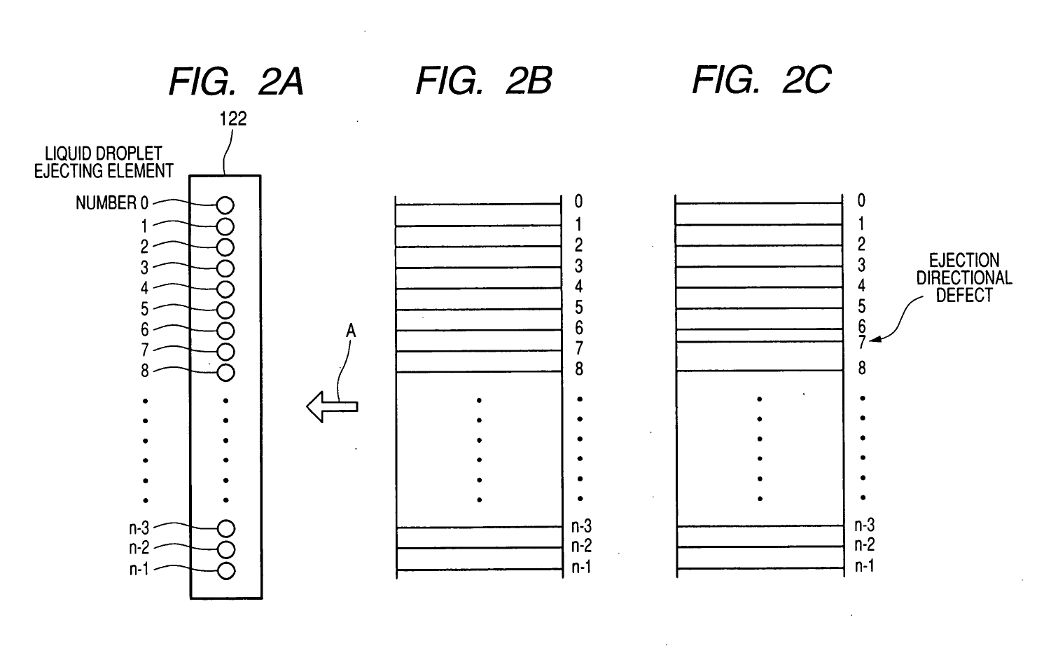

FIGS. 2A, 2B and 2C are explanatory diagrams of a test image printed out by the printer 12 on the basis of the test image data generated by the drawing control unit 100. Here, FIG. 2A is a schematic diagram of the liquid droplet ejecting head 122, FIG. 2B illustrates an example of the test image, and FIG. 2C illustrates an example of the test image when the liquid droplet ejecting head 122 has the liquid droplet ejecting element having the ejection directional defect.

In FIG. 2A, n liquid droplet ejecting elements are arrayed in the liquid droplet ejecting head 122. Each of the liquid droplet ejecting elements is displayed in an outline circle. The numbers of the liquid droplet ejecting elements are constituted by 0 to n-1 (n). An arrow A direction indicates the paper feeding direction and the liquid droplet ejecting elements are arrayed in the liquid droplet ejecting head 122 in a direction (for example, perpendicular to) crossing the paper feeding direction. Although FIG. 2A illustrates an example in which ejection ports of the liquid droplet ejecting elements are arrayed in series, the array of the ejection ports of the liquid droplet ejecting elements is not limited to it. The ejection ports may be evenly spaced in the direction perpendicular to the paper feeding direction identical to the arrow A direction and the ejection ports of the liquid droplet ejecting elements may be arrayed in two dimensions.

In FIG. 2B, in the test image, the drawing control unit 100 allows the n liquid droplet ejecting elements arrayed in the liquid droplet ejecting head 122 to draw sets of lines having the constant length in a predetermined direction (the paper feeding direction) of the recording medium on the basis of the test image data generated by the drawing control unit 100. Since the liquid droplet ejecting elements are arrayed in the liquid droplet ejecting head 122 at even intervals, the lines drawn as the test image are evenly spaced from each other. Although a start point and an end point of each of the straight lines are disposed on straight lines crossing the paper feeding direction, the straight lines each having the start point and the end point disposed on the same straight lines may not be perpendicular to the paper feeding direction A and may be obliquely inclined.

In an example of FIG. 2C, an ejection direction of a 7^{th} liquid droplet ejecting element is deviated from an ejection direction of a 6^{th} liquid droplet ejecting element. For this reason, an interval between straight lines drawn by the 7^{th} liquid droplet ejecting element and a 8^{th} liquid droplet ejecting element is widened. A position in which the interval is widened is referred to as a deviation position. In the example, the user can detect the ejection directional defect (a state in which the liquid droplets cannot be ejected in a proper direction) by checking the deviation position.

When there is a liquid droplet ejecting element having not the ejection directional defect but the non-ejection defect, which does not eject the liquid droplets, a straight line to be originally drawn does not exist. A position in which the straight line does not exist is referred to as an omission position. The user can detect the liquid droplet ejecting element having the non-ejection defect by checking the omission position.

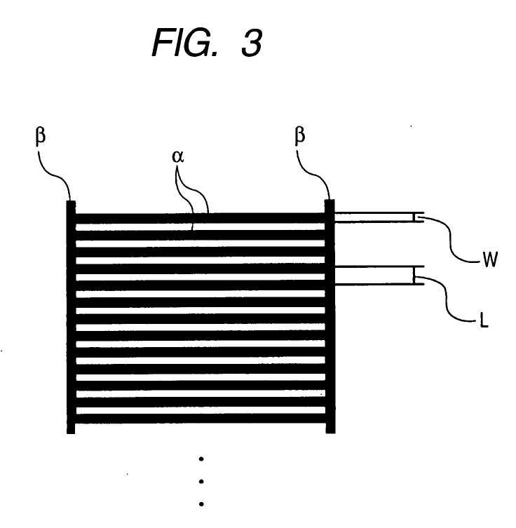

FIG. 3 is an explanatory diagram illustrating a drawing method for allowing the user to easily check the ejection directional defect in the test image. In FIG. 3, a plurality of lines α is drawn by the liquid droplet ejecting elements. Lines β have start points and end points of the lines α disposed on the lines β. Although the lines α are drawn as many as the number of the liquid droplet ejecting elements arrayed in the liquid droplet ejecting head 122, some of the lines α are shown in FIG. 3. Although drawing the lines β allows the user to easily check the ejection directional defect, the lines β may not drawn.

Here, it is preferable that a relationship between a width W of the line α and an interval L (an interval between the lines α) of lines adjacent to each other satisfies the following formula (1):

0.15<width of straight line/interval between straight lines<0.90 formula (1).

It is possible to detect a small deviation with drawing positions of the lines when the relationship satisfies the following formula (2):

0.20<width of straight line/interval between straight lines<0.70 formula (2).

It is possible to detect a smaller deviation when the relationship satisfies the following formula (3):

0.35<width of straight line/interval between straight lines<0.65 formula (3).

The above-mentioned relationships will be described in detail in an embodiment.

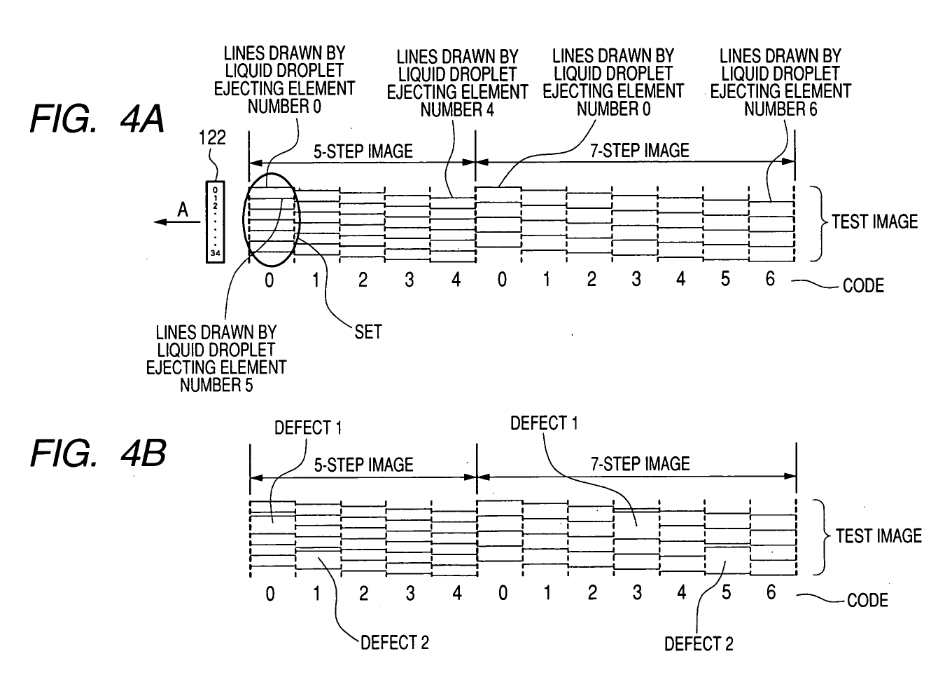

FIGS. 4A and 4B illustrate another example of the test image. The example illustrates a test image drawn in the liquid droplet ejecting head 122 having thirty five liquid droplet ejecting elements arrayed therein. A plurality of sets of lines is formed in the test image.

In FIG. 4A, regarding the test image, the drawing control unit 100 classifies the plurality of (thirty five) liquid droplet ejecting elements arrayed in the liquid droplet ejecting head 122 into a plurality of partial arrays successively arrayed therein, classifies a plurality of partial arrays so that the numbers of liquid droplet ejecting elements belonging to the partial arrays are combinations of the numbers (five and seven) not having a common divisor other than 1, and allows the liquid droplet ejecting elements disposed at corresponding positions in each kind of partial array to sequentially draw straight lines on the recording medium in a predetermined direction (a paper feeding direction A) of the recording medium, thereby generating the test image data and drawing it to the printer 12. The liquid droplet ejecting elements are arrayed in the liquid droplet ejecting head 122 in the direction crossing (perpendicular to) the paper feeding direction A. It is preferable that the straight lines of the sets have the substantially constant length.

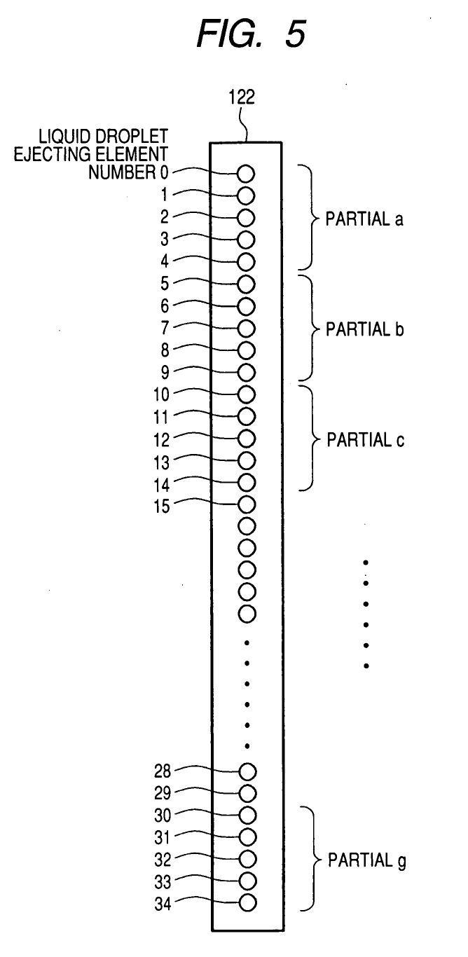

FIG. 5 illustrates an array example of the liquid droplet ejecting element in the liquid droplet ejecting head 122. In FIG. 5, thirty five liquid droplet ejecting elements are arrayed. Here, when numbers of 0 to 34 (total thirty five) are allocated to the liquid droplet ejecting elements, the number of partial arrays having five liquid droplet ejecting elements is set to seven (a to g) and the partial arrays a to g include liquid droplet ejecting elements 0 to 4, 5 to 9, 10 to 14, 15 to 19, 20 to 24, 25 to 29, and 30 to 34, respectively. Straight lines are drawn parallel to the paper feeding direction in the order of parentheses (I to V) by the liquid droplet ejecting elements disposed at corresponding positions in the partial arrays, that is, the print elements of I: (0, 5, 10, 15, 20, 25, and 30), II: (1, 6, 11, 16, 21, 26, and 31), III: (2, 7, 12, 17, 22, 27, and 32), IV: (3, 8, 13, 18, 23, 28, and 33), and V: (4, 9, 14, 19, 24, 29, and 34), whereby the 5-step image having five sets of straight lines constituted by seven parallel lines evenly spaced from each other formed therein is drawn. The parallel straight lines constituting each of the sets of lines preferably have the same length as each other, but the parallel straight lines may have lengths different from each other as long as a visibility is deteriorated. In FIG. 4A, although an example in which the liquid droplet ejecting elements in the parentheses perform the drawing of the lines at the same time is shown, the drawing may be performed by the liquid droplet ejecting elements at the timing when a start point and an end point of each of the lines belonging to the same set are disposed on straight lines. By this configuration, a test image may be formed which is deviated obliquely in the paper feeding direction. Although the parallel lines are drawn to the corresponding liquid droplet ejecting elements disclosed in the parentheses in the order of the parentheses in FIG. 4A, the order of the parentheses is not limited to it and the order of the parentheses may be different from the order of the parentheses disclosed in FIG. 4A. In the example of FIG. 4A, since the sets of lines are drawn in the order of the parentheses (I to V), the sets adjacent to each other are disposed at positions deviated by the intervals among the liquid droplet ejecting elements arrayed in the liquid droplet ejecting head in the direction perpendicular to the paper feeding direction A.

Similarly, the number of partial arrays each having seven liquid droplet ejecting elements is set to five, whereby a 7-step image is drawn in which seven sets of lines constituted by five parallel lines evenly spaced from each other are formed.

As described above, in FIG. 4A, the test image is formed of two straight line groups constituted by the 5-step image and the 7-step image. In this case, the numbers of sets belonging to the straight line groups are set to five and seven identical to the numbers of the liquid droplet ejecting elements belonging to the corresponding partial arrays, respectively. The numbers of sets in the straight line groups are formed of the combinations of the numbers each not having a common divisor other than 1 (the relationship is hereinafter referred to as a “relatively prime relationship”. It is preferable that the test image is drawn with one scanning of the liquid droplet ejecting head 122 by control performed by the head driving unit 120. Codes for identifying the liquid droplet ejecting elements may be drawn in the test image. The codes are denoted by numbers starting from 0, and numbers of 0 to 4 are attached to the codes in the 5-step image and numbers of 0 to 6 are attached to the codes in the 7-step image. Although the codes indicate the order of the parentheses (the order of I to V in the 5-step image) representing the liquid droplet ejecting elements used for drawing the sets of lines, the above-mentioned order may not be the order of I, II, III, IV, and V as described above. When the order is changed, the order of the codes shown in FIG. 4A, which correspond thereto, is also changed. For example, when the drawing order of each of the liquid droplet ejecting apparatus elements belonging to parentheses I and II is changed, the order of the codes corresponding thereto is also changed from 0→1 to 1→0.

Even in the above-mentioned 5-step image and 7-step image, it is preferable that the widths of the straight lines of each set and the intervals among the straight lines adjacent to each other satisfy the relationships shown in Equations (1), (2), and (3).

FIG. 4B illustrates an example of a test image at the time when some liquid droplet ejecting elements arrayed in the liquid droplet ejecting head 122 have an ejection directional defect. In the example, two liquid droplet ejecting elements have the ejection directional defect and are referred to as Defect 1 and Defect 2, respectively. Parts in which intervals between the straight lines are widened are produced in the 5-step image and the 7-step image due to the liquid droplet ejecting elements having the ejection directional defect. This reason is that an ejection direction on an upper side of the figure is deviated from a general ejection direction.

In the test image according to the embodiment, the compensation unit 104 specifies the liquid droplet ejecting elements having the ejection directional defect as described below on the basis of the position of the part having the widened interval between the straight lines (hereinafter, referred to as a deviation position). When there is a liquid droplet ejecting element which does not have the ejection directional defect but the non-ejection defect, an omission position in which a line to be originally drawn does not exist is produced, whereby the liquid droplet ejecting element having the non-ejection defect may be detected.

When the numbers of the liquid droplet ejecting elements are denoted by the numbers starting from 0 and the number of the liquid droplet ejecting element having the ejection directional defect is denoted by X, the deviation position is shown at the position of a code corresponding to a remainder of X÷5 in the 5-step image and the deviation position is shown at the position of a code corresponding to a remainder of X÷7 in the 7-step image. The numbers of sets belonging to the straight line groups, that is, the numbers of steps have a relatively prime relationship therebetween, whereby the combination thereof and the X have a one-to-one relationship therebetween. For this reason, the product of the numbers of steps becomes the maximum value of X which can be specified.

In the example of FIG. 4B, the deviation positions occurring due to Defect 1 correspond to the position of Code 0 in the 5-step image and to the position of Code 3 in the 7-step image. The values of the codes are input from the operation unit 16 by the user and the input values of the codes are transferred to the compensation unit 104 by the operation receipt unit 102. Here, the liquid droplet ejecting element number in Defect 1 is denoted by X and the relationship between the X and the deviation position input by the user is expressed by the following congruence expressions (1) and (2):

X≡0 (mod 5) Expression (1)

where a remainder of X÷5 is 0, and

X−3≡0 (mod 7) Expression (2)

where a remainder of (X−3)÷7 is 0.

X is the multiple of 5 in Expression (1) and thus, X=5k is obtained. When X=5k is substituted into the congruence expression of Expression (2),

5k−3≡0 (mod 7) Expression (3).

Accordingly, 5k≡3 (mod 7). By additional transformation, 7k−2k≡3 (mod 7).

Here, since 7k is dividable by 7 (the remainder thereof is 0),

−2k≡3 (mod 7) Expression (4).

Therefore, 2k≡−3 (mod 7). Accordingly, 2k≡4 (mod 7) and k≡2 (mod 7).

Accordingly, when k is divided by 7, the remainder thereof is 2, whereby k can be written by k=7I+2. Here, I is an integer number. When X is expressed by I,

X=5k=5(7I+2) Expression (5)=35I+10.

However, X=10 when 0≦X≦34, whereby the number of the liquid droplet ejecting element in Defect 1 corresponds to 10.

The deviation positions occurring due to Defect 2 correspond to the position of Code 1 in the 5-step image and to the position of Code 5 in the 7-step image. Accordingly, the congruence expressions thereof can be written by X−1≡0 (mod 5) and X−5≡0 (mod 7). When the expressions are solved in the same manner as in a case relating to Defect 1, X=26 and thus, the number of the liquid droplet ejecting element in Defect 2 is 26.

As described above, it is possible to specify the liquid droplet ejecting element having the ejection directional defect by means of the expressions called the congruence expression in the test image according to the embodiment. A calculation method using a sequential substitution method may be used for specifying the liquid droplet ejecting element having the ejection directional defect. For example, in an example of Defect 1, candidates satisfying the range of 0≦X≦34 as X=5a are shown in a table form (0, 5, 10, 15, 20, 25, and 30). It is judged whether remainders when subtracting 3 from candidates satisfying the expression of X=7b+3 are dividable by 7 among the above-mentioned candidates. The value (in this case, 10) of the corresponding candidate is specified as the number of the liquid droplet ejecting element having the ejection directional defect.

A predetermined table may be used for specifying the liquid droplet ejecting element having the ejection directional defect.

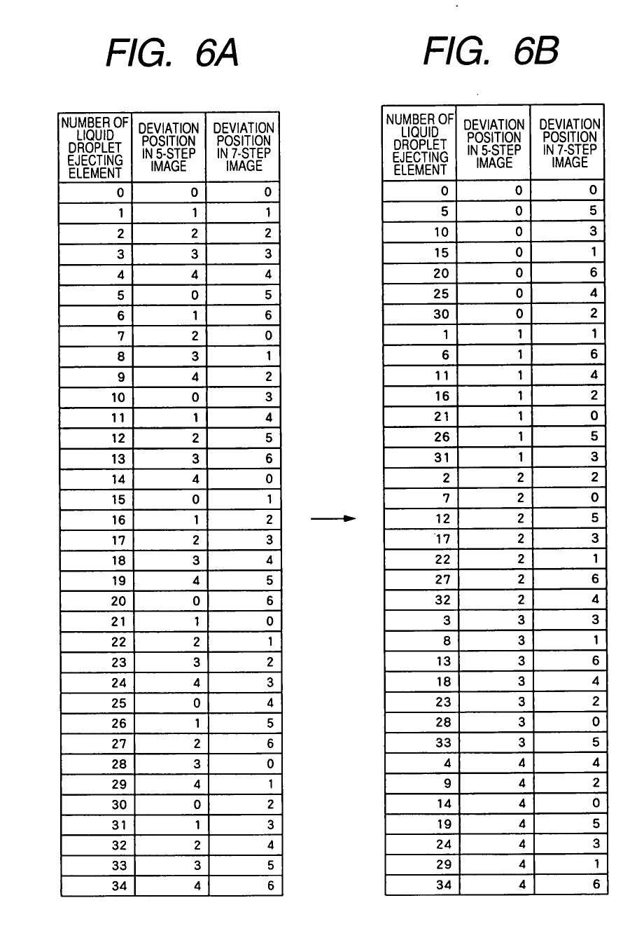

FIGS. 6A and 6B illustrate examples of tables used for specifying the liquid droplet ejecting elements each having the ejection directional defect. FIGS. 6A and 6B are tables used for specifying the liquid droplet ejecting elements each having the ejection directional defect in the liquid droplet ejecting head 122 having thirty five liquid droplet ejecting elements arrayed therein.

In FIG. 6A, when the liquid droplet ejecting elements each have the ejection directional defect, the deviation position occurring in each of the 5-step image and the 7-step image is organized by each of the numbers of the liquid droplet ejecting elements. As known from FIG. 5(a), the code of each deviation position is a remainder when dividing the number of the liquid droplet ejecting element by the step numbers (5 and 7).

FIG. 6B is a table organizing FIG. 6A at the deviation position in the 5-step image. As know from FIG. 6B, the deviation position in the 5-step image and the deviation position in the 7-step image are the sole combination with respect to thirty five liquid droplet ejecting elements.

The compensation unit 104 can specify the liquid droplet ejecting elements each having the ejection directional defect with reference to FIGS. 6A and 6B on the basis of the codes input through the operation unit 16 by the user. For example, in the case relating to the above-mentioned Defect 1, since the deviation position in the 5-step image corresponds to Code 0 and the deviation position in the 7-step image corresponds to Code 3, it is possible to specify the number of the liquid droplet ejecting element having the ejection directional defect as 10 from FIGS. 6A and 6B. Similarly, in the case relating to Defect 2, since the deviation position in the 5-step image corresponds to Code 1 and the deviation position in the 7-step image corresponds to Code 5, it is possible to specify the number of the liquid droplet ejecting element having the ejection directional defect as 26.

In the above-mentioned embodiment, the position of a set to which the deviation position belongs is checked without counting the number of the liquid droplet ejecting element having the ejection directional defect on the test image, whereby it is possible to easily and accurately specify the liquid droplet ejecting element having the ejection directional defect.

In the examples of FIGS. 4A and 4B, although the test image in which the liquid droplet ejecting elements of 5×7=35 are specified is shown, the array of the liquid droplet ejecting elements may not be the product of the relatively prime number such as thirty five. In this case, the number of the straight lines in some of the sets of straight lines constituting the test image corresponds to a number different from the number of the straight lines in other sets of straight lines. For example, when thirty four liquid droplet ejecting elements are arrayed, there is one set of straight lines less than the number of the straight lines by one straight line.

In the examples of FIGS. 4A and 4B, although the test image is formed of two straight line groups constituted by the 5-step image and the 7-step image, the test image may be formed of two straight line groups constituted by the 7-step image and a 11-step image, that is, another test image in which the numbers of the sets belonging to the straight line groups have the relatively prime relationship may be used. The number of the straight line groups constituting the test image is not also limited to two and the test image may be formed of more than three straight line groups including a test image formed of three straight lines groups including the 3-step image, the 5-step image, and the 7-step image.

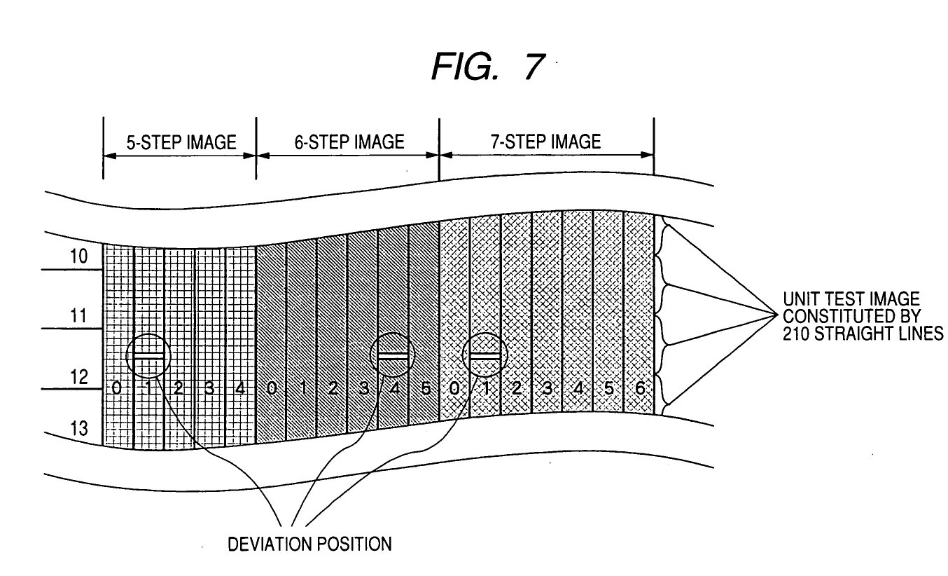

FIG. 7 illustrates another example of the test image. FIG. 7 illustrates an example of a case in which the number of the liquid droplet ejecting elements arrayed in the liquid droplet ejecting head 122 becomes multiple. In a liquid droplet ejecting head having a print width equal to or larger than the width of a recording area of the recording medium, the number of the liquid droplet ejecting elements increases, for example, the liquid droplet ejecting head 122 may have 7,880 liquid droplet ejecting elements arrayed therein.

In the example of FIG. 7, the test image is formed of the above-mentioned 5-step image having five sets of lines, 6-step image having six sets of lines, and 7-step image having seven sets of lines. Here, since 5, 6, and 7 have the relatively prime relationship therebetween and it is possible to solely specify the liquid droplet ejecting elements of 5×6×7=210 from the deviation position of each step. Since it is necessary to add test images having more steps so as to specify the liquid droplet ejecting elements of the above-mentioned number or more, the intervals between the straight lines are widened. Accordingly, it is impossible to maintain relationships shown in Expressions (1) to (3). Therefore, it becomes difficult to solely the 7,880 liquid droplet ejecting elements. In the test image of the example, unit test images are formed by separating straight lines drawn by the 210 liquid droplet ejecting elements in the array directions of the liquid droplet ejecting elements in the liquid droplet ejecting head 122. Regarding 210 straight lines in the unit test images, the 5-step image (42 straight lines), the 6-step image (35 straight lines), and the 7-step image (30 straight lines) are formed by the sets of lines as many as the numbers of the corresponding steps in the same order as the order shown in FIGS. 4A and 4B. Numbers for identifying the unit test images are also allocated to the unit test images. The numbers start from 0. In FIG. 7, the straight lines constituting the test image are omitted. The deviation positions occurring by the liquid droplet ejecting element having the ejection directional defect are each indicated by two parallel lines.

In FIG. 7, in 12^{th} unit test image, the deviation positions occur at a position of Code 1 in the 5-step image, at a position of Code 4 in the 6-step image, and at a position of Code 1 in the 7-step image. From the result, the number of the liquid droplet ejecting element having the ejection directional defect can be specified as number 106 in the 12^{th} unit test image by using the congruence expressions and the predetermined table described in FIGS. 4A and 4B. Next, the number of the corresponding unit test image shown on the left side is 12. Accordingly, it is possible to recognize that a liquid droplet ejecting element of number 2,416 (210×12+106=2,416) has the ejection directional defect.

In the example of FIG. 7, when there is the liquid droplet ejecting element having not the ejection directional defect but the non-ejection defect, the omission position where the line to be originally drawn does not exist occurs. Accordingly, the liquid droplet ejecting element having the non-ejection defect may be detected.

The liquid droplet ejecting head 122 of according to the embodiment has the print width equal to or larger than the width of the recording area of the recording medium, whereby it is difficult to draw the codes outside the test image. Therefore, the codes are drawn within the test image.

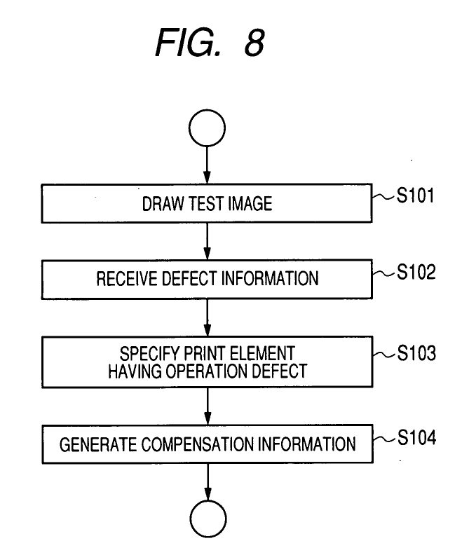

FIG. 8 illustrates a flow of an operation example of the print control device 10 according to the embodiment. In FIG. 8, the drawing control device 100 generates test image data and allows each of the liquid droplet ejecting elements arrayed in the liquid droplet ejecting head 122 of the printing apparatus 12 to draw the test image (S101). The test image is drawn on the recording medium such as the printing paper. When the printer 12 has a color printing function, the test image is drawn for each of colors of K (black), C (cyan), M (magenta), and Y (yellow).

Next, the user checks whether or not a deviation position occurs with reference to the recording medium on which the test image is drawn. When the deviation position occurs, a code indicating the position thereof is input through the operation unit 16. The operation receipt unit 102 receives the input code as defect information. When there is a liquid droplet ejecting element having the non-ejection defect, the code indicating the omission position is input as the defect information (S102). In this case, the operation receipt unit 102 serves as defect information receiving means of the invention.

The operation receipt unit 102 transfers the received code to the compensation unit 104 and the compensation unit 104 specifies the liquid droplet ejecting elements each which have the ejection directional defect or the non-ejection defect (both sides are referred to as an “operation defect”) in accordance with an order described in FIGS. 2A, 2B and 2C, FIGS. 4A and 4B, and FIG. 7 described above (S103). It is preferable to store information on the liquid droplet ejecting elements having the specified operation defect in the storage unit 110.

Next, the compensation unit 104 generates compensation information used for compensating printing operations of the liquid droplet ejecting elements arrayed in the liquid droplet ejecting head 122 so as to reduce influences of the specified liquid droplet ejecting elements each having the operation defect (S104).

It is preferable to change the printing operation depending on the kind of used recording medium by acquiring information on whether the used recording medium is plain paper or glossy paper in advance. In general, the glossy paper requires a high image quality and has a high sensitivity to the ejection directional defect. Meanwhile, the plain paper requires a high printing speed and has a low sensitivity to the ejection directional defect. A printing method includes one-pass recording in which the formation of an image is completed by one scanning operation and multiple-pass recording in which the formation of an image is completed by multiple scanning operations with respect to the same area of the recording medium. In the one-pass recording, a printing speed increases, but when there is the liquid droplet ejecting element having the operation defect, a high image quality is difficult to realize. Meanwhile, in the multiple-pass recording, the printing speed decreases, but the ejection directional defect or a mechanical line break error is averaged by the multiple scanning operations. Accordingly, a stripe, a spot, and the like are reduced and thus, it is possible to realize the high image quality. A control in which a nozzle passes multiple times with respect to any one line can be performed. Accordingly, even though there is the liquid droplet ejecting element having the operation defect, an alternative recording operation is performed on a part prepared to be printed with the liquid droplet ejecting element by another liquid droplet ejecting element having a normal operation, whereby it is possible to also realize the high image quality in this point. Therefore, when the liquid droplet ejecting element having the operation defect is specified during the printing operation with the one-pass recording in Step S103, it is preferable that the compensation unit 104 generates compensation information indicating that the one-pass recording is continued when the recording medium is the plain paper and the one-pass recording is switched to the multiple-pass recording when the recording medium is the glossy paper.

Switching between the one-pass recording and the multiple-pass recording may be performed in accordance with a criterion shown in Table 1. The content of Table 1 is stored in the storage unit 110 in advance.

TABLE 1

| | | Non-ejection | Ejection |
|---|---|---|---|
| | Non-ejection | defect and ejection | directional defect |
| | defect only | directional defect | only |
| Plain paper | Number of passes → | Number of passes → | Number of passes → |
| | multiple passes | multiple passes | one pass |
| | Unused liquid | Unused liquid | Unused liquid |
| | droplet ejecting | droplet ejecting | droplet ejecting |
| | element → | element → | element → none |
| | non-ejection | non-ejection | |
| | defect | defect and ejection | |
| | | directional defect | |
| Glossy paper | Number of passes → | Number of passes → | Number of passes → |
| | multiple passes | multiple passes | multiple passes |
| | Unused liquid | Unused liquid | Unused liquid |
| | droplet ejecting | droplet ejecting | droplet ejecting |
| | element → | element → | element → ejection |
| | non-ejection | non-ejection | directional defect |
| | defect | defect and ejection | |
| | | directional defect | |

In Table 1, in case that the recording medium is the plain paper, another liquid droplet ejecting element having the normal operation performs the printing operation on the plain paper without using the liquid droplet ejecting element having the operation defect by switching the one-pass recording to the multiple-pass recording when the liquid droplet ejecting element having the non-ejection defect exists and the liquid droplet ejecting element having the non-ejection defect and the liquid droplet ejecting element having the ejection directional defect coexist as the liquid droplet ejecting element having the operation defect. Meanwhile, when the liquid droplet ejecting element having the operation defect is only the liquid droplet ejecting element having the ejection directional defect, the one-pass recording is performed and the liquid droplet ejecting element having the ejection directional defect is just used. In the plain paper, the reason is that even though the ejection direction is deviated, the deviation does not stand out in general.

Meanwhile, in case that the recording medium is the glossy paper, another liquid droplet ejecting element having the normal operation performs the printing operation on the glossy paper without using the liquid droplet ejecting element having the operation defect by switching the one-pass recording to the multiple-pass recording in any one of the non-ejection defect and the ejection directional defect when the liquid droplet ejecting element having the operation defect.

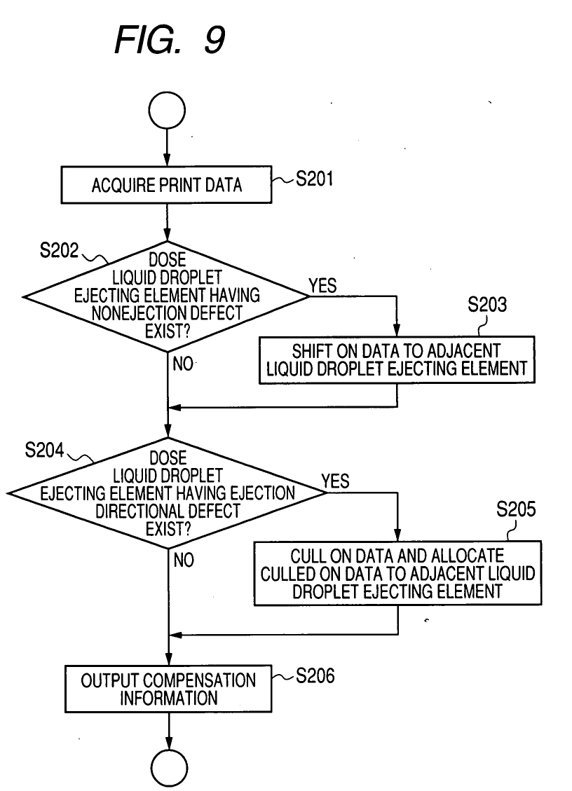

FIG. 9 illustrates a flow of another operation example of the print control device 10 according to the embodiment. FIG. 9 is an operation example when the compensation unit 104 changes a method of processing the print data in accordance with the condition of the liquid droplet ejecting element.

In FIG. 9, the compensation unit 104 acquires the print data generated by the drawing control unit 100 (S201). The print data includes data on ON (ejection operation) or OFF (non-ejection operation) of each of the liquid droplet ejecting elements.

Next, the compensation unit 104 checks the status of each of the liquid droplet ejecting elements and judges whether or not the liquid droplet ejecting element having the non-ejection defect exists (S202). When the liquid droplet ejecting element having the non-ejection defect exists, the print data is compensated so that the ink droplets are ejected by the adjacent liquid droplet ejecting element by shifting ON data allocated to the corresponding liquid droplet ejecting element to OFF data of the adjacent liquid droplet ejecting element (S203). By this configuration, a pixel to be drawn by the liquid droplet ejecting element having the non-ejection defect is drawn by the adjacent liquid droplet ejecting element in place of the liquid droplet ejecting element having the non-ejection defect. For this reason, it is possible to prevent the pixel from being omitted in the multiple-pass recording and thus, it is possible to disable the omission of the pixel from standing out by substituting the omitted pixel by the pixel of the adjacent pixel even in the one-pass recording.

Meanwhile, when the liquid droplet ejecting element having the non-ejection defect does not exist in S202 or after the compensation process is performed in S203, the compensation unit 104 judges whether or not the liquid droplet ejecting element having the ejection directional defect exists (S204). When the liquid droplet ejecting element having the ejection directional defect exists, the ON data allocated to the liquid droplet ejecting element is culled at a constant rate and the print data is compensated so that the culled ON data is allocated to the adjacent liquid droplet ejecting element (S205). It is possible to disable the ejection directional defect from standing out by properly determining the rate culling the ON data.

The compensation unit 104 outputs the compensation information generated in the above steps from the output unit 106 to the printer 12 (S206).

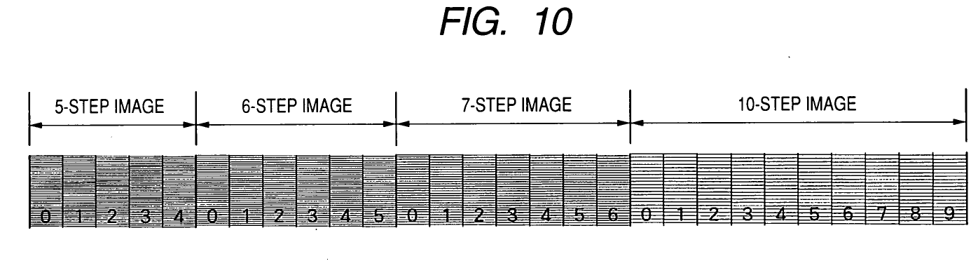

FIG. 10 illustrates another example of the test image. In FIG. 10, the test image is formed of the 5-step image, the 6-step image, the 7-step image, and the 10-step image. Among them, the 5-step image, the 6-step image, and the 7-step image are the test images for specifying the numbers (210 numbers of 0 to 209) of the liquid droplet ejecting elements having the non-ejection defect or the ejection directional defect. The 10-step image is the test image for judging the degree of the ejection directional defect, that is, the deviation of the ejection direction is large or small with respect to the liquid droplet ejecting element having the ejection directional defect.

Although the 10-step image, that is, the test image in which the straight lines are drawn at an interval larger than the interval of the lines in the straight line group of each of the 5-step image, the 6-step image, and the 7-step image is used as the test image for judging the degree of the ejection directional defect in the example of FIG. 10, the straight lines may be drawn at the smaller interval. For example, when the 3-step image is used, the test image is formed in which the straight lines are drawn at an interval smaller than the interval between the straight lines in the straight line group of each of the 5-step image, the 6-step image, and the 7-step image.

The user inputs the code of the omission position (non-ejection defect) or the deviation position (ejection directional defect) and information on whether the operation defect of the liquid droplet ejecting element is the non-ejection defect or the ejection directional defect through the operation unit 16. When the operation defect is the ejection directional defect, the user inputs the deviation position in each of the 5-step image, the 6-step image, and the 7-step image and inputs the deviation position in the 10-step image only when the deviation position is visible. This reason is that the interval between the straight lines is widened in the 10-step image. Accordingly, when the ejection directional defect is small, the deviation position is difficult to stand out (invisible). As a result, when the deviation position in the 10-step image is input, it is judged that the ejection directional defect is large and when the deviation position in the 10-step image is not input, it is judged that the ejection directional defect is small.

As described above, in accordance with the test images shown in FIG. 10, it is possible to specify the liquid droplet ejecting elements having the large ejection directional defect, the small ejection directional defect, and the non-ejection defect.

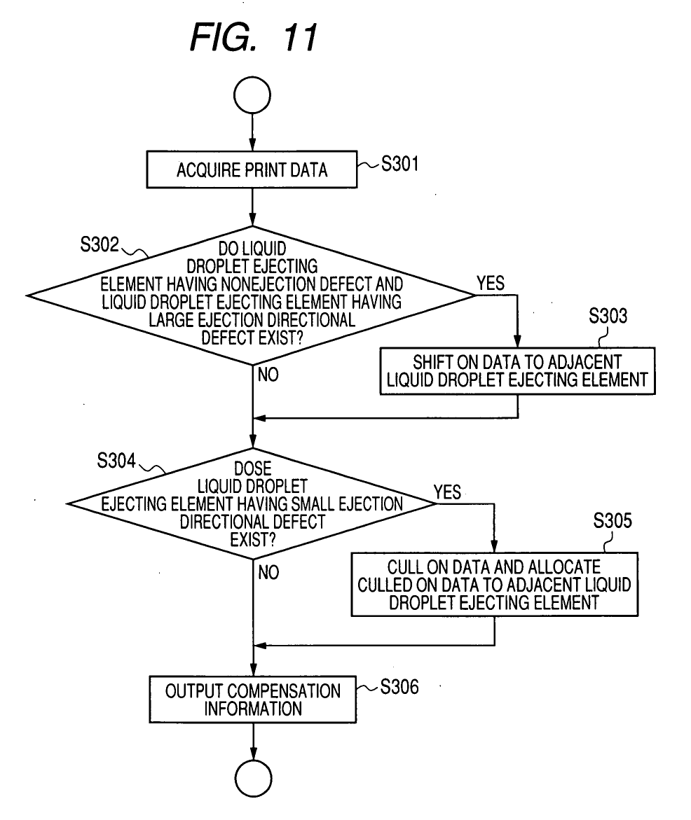

FIG. 11 illustrates a flow of another operation example of the print control device 10 according to the embodiment. FIG. 11 illustrates an operation example in a case in which the compensation unit 104 changes the method of processing the print data depending on the liquid droplet ejecting elements having the large ejection directional defect, the small ejection directional defect, and the non-ejection defect specified in FIG. 10.

In FIG. 11, the compensation unit 104 acquires the print data generated by the drawing control unit 100 (S301). The print data includes data on the ON and the OFF of each liquid droplet ejecting element.

Next, the compensation unit 104 checks the status of each of the liquid droplet ejecting elements and judges whether or not the liquid droplet ejecting element having the non-ejection defect and the liquid droplet ejecting element having the large ejection directional defect exist (S302). When the liquid droplet ejecting element having the non-ejection defect and the liquid droplet ejecting element having the large ejection directional defect exist, the print data is compensated so that the ink droplets are ejected by the adjacent liquid droplet ejecting element by shifting ON data allocated to the liquid droplet ejecting element to OFF data of the adjacent liquid droplet ejecting element (S303). By this configuration, pixels to be drawn by the liquid droplet ejecting element having the non-ejection defect and the liquid droplet ejecting element having the large ejection directional defect are drawn by the adjacent liquid droplet ejecting element in place of the liquid droplet ejecting element having the non-ejection defect and the liquid droplet ejecting element having the large ejection directional defect. By this configuration, it is possible to reduce influences of the liquid droplet ejecting element having the non-ejection defect and the liquid droplet ejecting element having the large ejection directional defect on the image quality of the liquid droplet ejecting element.

Meanwhile, when the liquid droplet ejecting element having the non-ejection defect and the liquid droplet ejecting element having the large ejection directional defect do not exist in S302 or after the compensation process is performed in S303, the compensation unit 104 judges whether or not the liquid droplet ejecting element having the small ejection directional defect exists (S304). When the liquid droplet ejecting element having the small ejection directional defect exists, the ON data allocated to the corresponding liquid droplet ejecting element is culled at a constant rate and the print data is compensated so that the culled ON data is allocated to the adjacent liquid droplet ejecting element (S305). It is possible to disable the ejection directional defect from standing out by properly determining the rate culling the ON data.

The compensation unit 104 outputs the compensation information generated in the above steps from the output unit 106 to the printer 12 (S306).

A program for executing each of the steps described in FIGS. 8, 9, and 11 may be provided by communication means and may be provided by storage in a storage medium such as a CD-ROM.

### Embodiment

Hereinafter, an embodiment in which an influence of a ratio (W/L) of the width W of each of the straight lines α shown in FIG. 3 to the interval L between straight lines adjacent to each other (the interval between the straight lines α) on easy discrimination of the ejection directional defect is checked will be described.

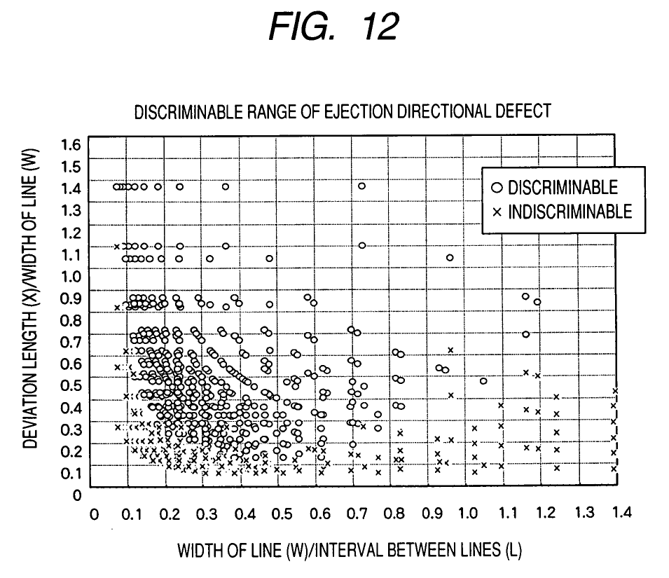

FIG. 12 illustrates a test result a discriminable range of the ejection directional defect. In FIG. 12, a horizontal axis represents the value of W/L and a vertical axis a ratio (X/W) of a deviation length X of the straight line drawn by the liquid droplet ejecting element having the ejection directional defect and the width W of each of the straight lines α. A visibility of the straight line is judged with eyes under a condition corresponding to a plurality of coordinates (W/L, X/W) by changing the values of W, L, and X with respect to the two axes. Specifically, it is judged whether or not locations whether the deviation occurs can be recognized with eyes by intentionally deviating the straight line among the test images of from the 1-step image to the 10-step image. The line width W is set to a value measured by DA6000 under a plurality of conditions by varying the diameter of each of the ink droplets with a plurality of different driving signals.

The test condition employed in the embodiment is given by:

Intervals between straight lines (10 kinds): 44, 88, 132, 176, 220, 265, 309, 353, 397, and 441 μm

Deviation length (5 kinds): 8.8, 17.6, 26.5, 35.3, and 44.1 μm

Width of line (15 kinds): 32.7, 41.7, 49.6, 52.5, 62.1, 63.5, 73.1, 74.1, 78.9, 82.7, 91.0, 102.0, 112.0, 120.0, and 135.0 μm.

In accordance with the above-mentioned 450 condition, a case in which the locations where the deviation occurs can be recognized is indicated by 0 and a case in which the location where the deviation occurs can be recognized is indicated by X are shown in FIG. 12.

Recording paper: plain paper (manufactured by Fuji Xerox Co., Ltd., C2 paper)

Available ink: black

Line width measuring instrument: manufactured by Oji Scientific Instruments Co., Ltd., DA6000

As shown in FIG. 12, a deviation in which a ratio of 0.4 or more in deviation length/width of line (X/W) becomes recognizable in the range of 0.15<W/L<0.90. In this case, when the test image is drawn at 600 dpi and in a line width of 75 μm, a deviation of 30 μm becomes visible in the 2-step image to the 11-step image.

A deviation of 0.2 or more in X/W becomes recognizable in the range of 0.20<W/L<0.70. In this case, when the test image is drawn at 600 dpi and in the line width of 75 μm, a deviation of 15 μm becomes recognizable in the 3-step image to the 8-step image.

A deviation of 0.15 or more in X/W becomes recognizable in the range of 0.35<W/L<0.65. In this case, when the test image is drawn at 600 dpi and in the line width of 75 μm, a deviation of 11.25 μm becomes recognizable in the 3-step image to the 5-step image.

As described above, it is preferable that W/L is set to the above-mentioned three ranges in accordance to the relationship between the deviation length and the line width to be recognized.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. A recording medium on which a test image testing an operation to a plurality of liquid droplet ejecting elements arrayed in a liquid droplet ejecting head is drawn,
the test image comprising a straight line set having a predetermined number of straight lines which are evenly spaced from each other, and being drawn parallel to each other in a predetermined direction, each of the straight lines having start points and end points which are disposed thereon, and
the test image having ratio of width of each of the straight lines to interval between the straight lines adjacent to each other, the ratio satisfying the following formula (1):
0.15<the width of each of the straight lines/the interval between the straight lines<0.90 (1).

2. The recording medium as claimed in claim 1, wherein the ratio of the width of each of the straight lines to the interval between the straight lines adjacent to each other satisfies the following formula (2):
0.20<the width of each of the straight line/the interval between the straight lines<0.70 (2).

3. The recording medium as claimed in claim 2, wherein the ratio of the width of each of the straight lines to the interval between the straight lines adjacent to each other satisfies the following formula (3):
0.35<the width of each of the straight line/the interval between the straight lines<0.65 (3).

4. The recording medium as claimed in claim 1, wherein the test image comprises a plurality of straight line sets drawn in predetermined direction.

5. The recording medium as claimed in claim 4,
wherein
the test image comprises a plurality of straight line groups including the plurality of straight line sets,
the numbers of straight line sets belonging to the plurality of straight line groups are different from each other, and
the numbers of straight line sets belonging to the plurality of straight line groups are a combination of numbers not having a common divisor other than 1.

6. The recording medium as claimed in claim 5,
wherein
in each the plurality of straight line groups, the plurality of straight line sets adjacent to each other are disposed at positions deviated by the interval between the liquid droplet ejecting elements arrayed in the liquid droplet ejecting head in a direction perpendicular to the predetermined direction.

7. The recording medium as claimed in claim 5, wherein the test image includes a straight line set that has an interval larger or smaller than interval between the plurality of straight lines in each of the plurality of straight line groups.

8. The recording medium as claimed in claim 6, wherein the test image includes a straight line set that has an interval larger or smaller than interval between the plurality of straight lines in each of the plurality of straight line groups.

9. A print control device comprising a drawing controller causing a plurality of liquid droplet ejecting elements arrayed in a liquid droplet ejecting head to draw a test image used for checking operation statuses of the liquid droplet ejecting elements on a recording medium,
the drawing controller causing the plurality of liquid droplet ejecting elements to draw straight lines parallel to each other in a predetermined direction on the recording medium, and
the test image having ratio of width of each of the straight lines to interval between the straight lines adjacent to each other, the ratio satisfying the following formula (4):
0.15<the width of each of the straight lines/the interval between the straight lines<0.90 (4).

10. A printing system comprising:
a liquid droplet ejecting head that includes a plurality of liquid droplet ejecting elements, and that prints image data on a recording medium;
a drawing controller that classifies the plurality of arrayed liquid droplet ejecting elements into a plurality of partial arrays successively arrayed, classifies the plurality of partial arrays into a plurality of patterns so that the numbers of the liquid droplet ejecting elements belonging to the partial arrays are combinations of numbers not having a common divisor other than 1, allows the liquid droplet ejecting elements disposed at corresponding positions in the patterns of partial arrays to sequentially draw straight lines on the recording medium in a predetermined direction of the recording medium so as to causes the liquid droplet ejecting elements to draw a test image used for checking operation statuses of the liquid droplet ejecting elements;
a defect information receiver that receives defect information on a liquid droplet ejecting element having one of a non-ejection defect and an ejection directional defect checked on the basis of the test image; and
a compensation unit that compensates the printing operation of the liquid droplet ejecting head on the basis of the defect information.

11. The printing system as claimed in claim 10, wherein the compensation unit switches a recording method in which the printing operation is performed by multiple scanning operations performed by the liquid droplet ejecting head and another recording method in which the printing operation is performed by one scanning operation performed by the liquid droplet ejecting head into each other with respect to the same area of the recording medium on the basis of the defect information.

12. The printing system as claimed in claim 10,
wherein
the defect information receiver receives the defect information on the liquid droplet ejecting element having the ejection directional defect, and
the compensation unit culls print data of the liquid droplet ejecting element having the ejection directional defect at a predetermined rate on the basis of the defect information and allocates the culled print data to the adjacent liquid droplet ejecting element.

13. The printing system as claimed in claim 10,
wherein
the defect information includes information on whether or not the ejection directional defect exists and the degree of the ejection directional defect, and
the compensation unit adds all print data of the liquid droplet ejecting element having the degree of the ejection directional defect exceeding a predetermined level to liquid droplet ejecting elements adjacent thereto on the basis of the defect information.

14. A computer readable medium storing a program causing a computer to execute a process for easily specifying a print element having one of a non-ejection defect and an ejection directional defect with eyes, the process comprising:
drawing a test image for checking operation statuses of liquid droplet ejecting elements on a recording medium with a plurality of liquid droplet ejecting elements arrayed in a liquid droplet ejecting head;
receiving defect information on liquid droplet ejecting elements each having one of the non-ejection defect and the ejection directional defect checked based on the test image;
compensating the printing operation of the liquid droplet ejecting head on the basis of the defect information;
classifying the plurality of liquid droplet ejecting elements arrayed in the liquid droplet ejecting head into a plurality of partial arrays successively arrayed therein;
classifying the plurality of partial arrays into a plurality of patterns so that the numbers of the liquid droplet ejecting elements belonging to the partial arrays are combinations of numbers not having a common divisor other than 1; and
allowing the liquid droplet ejecting elements disposed at corresponding positions in the patterns of partial arrays to sequentially draw straight lines.
